(19) United States
(12) Patent Application Publication
(10) Pub. No.: US 2015/0278447 A1
(43) Pub. Date: Oct. 1, 2015

(54) System and Method for Updating Medical Records of a Third-party Medical Provider over a Computer Network

(71) Applicant: Mario Quintanillo, Bellaire, TX (US)

(72) Inventor: Mario Quintanillo, Bellaire, TX (US)

(21) Appl. No.: 14/225,458

(22) Filed: Mar. 26, 2014

(51) Int. Cl. G06F 19/00; G06Q 50/24

(52) U.S. Cl. CPC G06F 19/322; G06Q 50/24

(57) ABSTRACT

A system and method for updating medical records of a third-party medical provider over a computer network is herein disclosed. The system can comprise a server memory, and a server processor. The server memory that stores a client profile, a session information, and a virtual care website. The session information related to each of the client profile. The server processor that according to instructions from the virtual care website captures the session information between a physician and a patient through a virtual chat application. The patient related with the client profile. Moreover, according to the instructions from the virtual care website queries a third-party medical provider to match patient information with said patient. The patient information is associated with one or more medical records. Additionally, according to the instructions from the virtual care website stores the session information under the medical records of the patient that matches the client profile.

### BACKGROUND

This disclosure relates to a system and method for updating medical records of a third-party medical provider over a computer network. For purposes of this disclosure, various aspects of a computer application are discussed, and are an example of potential embodiments. However, such discussion of any particular application is solely exemplary, and not limiting.

Methods for treating patients have evolved over the years. At one time, it was not uncommon for a doctor to make a house call for a sick patient. As towns grew, and as the practice of medicine began to require the use of equipment that could not fit into a doctor's bag, the practice of home visits waned, and the common practice became patients going to the doctor's office to get a better level of care.

However, as medical care improved, the costs began to increase. To cover these costs, people began to look to solutions such as medical insurance. While medical insurance has helped many achieve a level of care they expect, many still choose to not maintain insurance or simply cannot afford it. Further, many of these uninsured turn to emergency rooms to replace a primary care physician, knowing that an emergency room will not turn away a patient based on the patient's inability to pay. As a consequence, emergency rooms often are plagued with overcrowding. The fact that many who receive these services do not pay only raises the cost of an emergency room visit even more. Today, a person who visits an emergency room, and who only sees a doctor, without x-rays or other procedures, can expect a bill in the hundreds of dollars.

High costs in medicine, however, are not limited to the emergency room. With an aging population, more people with access to health care now than ever before, high malpractice insurance costs, and expensive technology required to practice, even a routine visit to the doctor can be quite costly. As such, the medical industry is trying to find ways to find ways to serve patients while not reducing the quality of care. One way to achieve this is to help a person achieve the correct level of care for his or her ailment or prevention of ailments. For example, by diverting a person with a cold from the emergency room to a non-emergency doctor's office, less money is spent in treatment, thus making our healthcare market more efficient. Another way to achieve patient service is by cutting costs. When prices go down, more people are able to pay for services, bringing more resources into the health care market.

One potential for improvement within patient care efficiency is providing ways for patients requiring minor or non-emergency care to get medical care from a physician without having to be physically present in the doctor's office. There is also a need for a system that can gather information from a remote patient and store the information within the patient's medical records. Additionally, there is a need for such system to integrate with present medical records database solutions. Further, there is a need for doctors providing such services to network with other service providers.

Accordingly, it would be useful to have a system and method for updating medical records of a third-party medical provider over a computer network.

### SUMMARY

A system and method for updating medical records of a third-party medical provider over a computer network is herein disclosed. The system can comprise a server memory, and a server processor. The server memory that stores a client profile, a session information, and a virtual care website. The session information related to each of the client profile. The server processor that according to instructions from the virtual care website captures the session information between a physician and a patient through a virtual chat application. Further, the patient related with the client profile. Moreover, according to the instructions from the virtual care website queries a third-party medical provider to match patient information with said patient. The patient information is associated with one or more medical records. Additionally, according to the instructions from the virtual care website stores the session information under the medical records of the patient that matches the client profile.

In another embodiment, a method for updating medical records of a third-party medical provider over a computer network is herein disclosed. The method can comprise the step capturing a session information between a physician and a patient through a virtual chat application. Further, the patient related with a client profile. Moreover the method can comprise the step querying a third-party medical provider to match a patient information with the patient. The patient information associated to one or more medical records. Additionally, the method can comprise the step storing the session information under the medical records of the patient that matches the client profile.

Lastly, the system can comprise a non-transitory computer readable storage medium having a computer readable program code embodied therein. The computer readable program code can be adapted to be executed to implement the above mentioned method.

### BRIEF DESCRIPTION OF THE DRAWINGS

FIG. 1 illustrates a web-based emergency care system comprising a patient computer, a physician computer, and one or more server.

FIG. 2 illustrates an embodiment of computers.

FIG. 3 illustrates a schematic diagram of a server according to an embodiment of the present disclosure.

FIG. 4 illustrates a virtual care data storage comprising client profile information and one or more session information.

FIG. 5 illustrates an embodiment of a virtual care website comprising a user sign up link, and a user sign in link.

FIG. 6 illustrates a physician chat window during a web-based medical consultation session.

FIG. 7 illustrates a patient chat window during a web-based medical consultation session.

FIG. 8 illustrates a web-based emergency care system further comprising a primary care physician (PCP) patient record database.

FIG. 9 illustrates a primary care physician (PCP) patient record database comprising a patient's information and one or more medical records.

FIG. 10 illustrates a virtual care multiple site server system.

FIG. 11 illustrates a schematic diagram of a multiple site server according to an embodiment of the present disclosure.

FIG. 12 illustrates a provider profiles comprising a provider's account information, and a virtual care website unique data.

FIG. 13A illustrates a centralized hosting structure of a multiple site server comprising a central site, and a plurality of provider sites.

FIG. 13B illustrates a centralized hosting structure for a multiple site server 1001 further comprising a provider network.

FIG. 14 illustrates an embodiment of a multiple site server website comprising one or more authentication section, and a medical provider section.

FIG. 15 illustrates a design page of a multiple site server website.

FIG. 16 illustrates an exemplary method for controlling a patient's camera to capture an image information upon a physician's request.

FIG. 17 illustrates an exemplary method for updating medical records of a third-party medical provider over a computer network.

### DETAILED DESCRIPTION

Described herein is a system and method for updating medical records of a third-party medical provider over a computer network. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

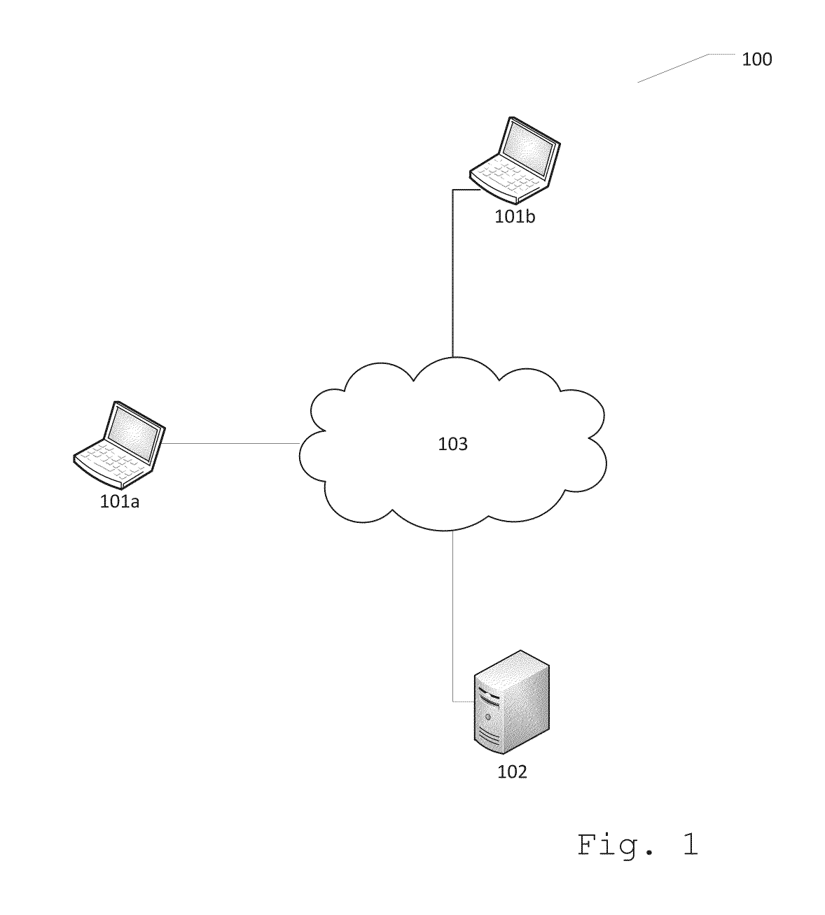

FIG. 1 illustrates a web-based emergency care system 100 comprising a patient computer 101a, a physician computer 101b, and one or more server 102. Patient computer 101a and provider computer 101b can each be a desktop computer, laptop, tablet, or smartphone. Server 102 represents at least one, but can be many servers, each connected to network 103 capable of performing computational task, and storing data information. Server 102 can be accessible to an individual or an institution through a web browser providing health care services. Network 103 can be a local area network (LAN), a wide area network (WAN), a piconet, or a combination of LANs, WANs, or piconets. One illustrative LAN is a network within a single business. One illustrative WAN is the Internet. In the preferred embodiment, network 103 will comprise the Internet.

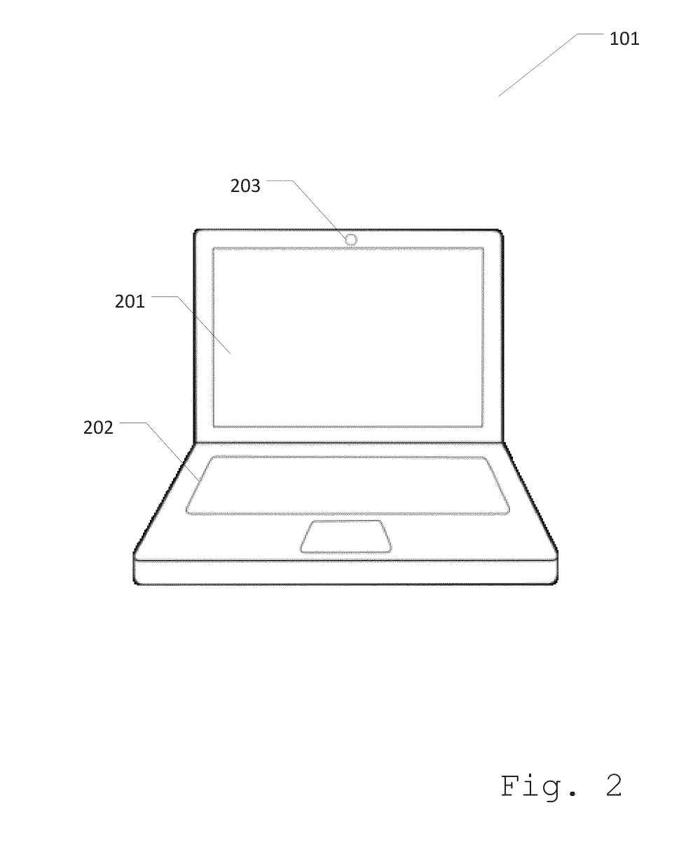

FIG. 2 illustrates an embodiment of computers 101. Computer 101 can comprise or be connectable to input/output devices such as a screen 201, a keypad 202, and a camera 203. A camera can be built-in or external. Screen 201 can be a mere display output, or can also be a touch screen. Keypad 202 can comprise of a plurality of physical buttons on mobile device, however in an embodiment were screen 201 is a touch screen, keypad 202 can be represented virtually on screen 201. Input/output devices can be used for capturing and communicating data 204.

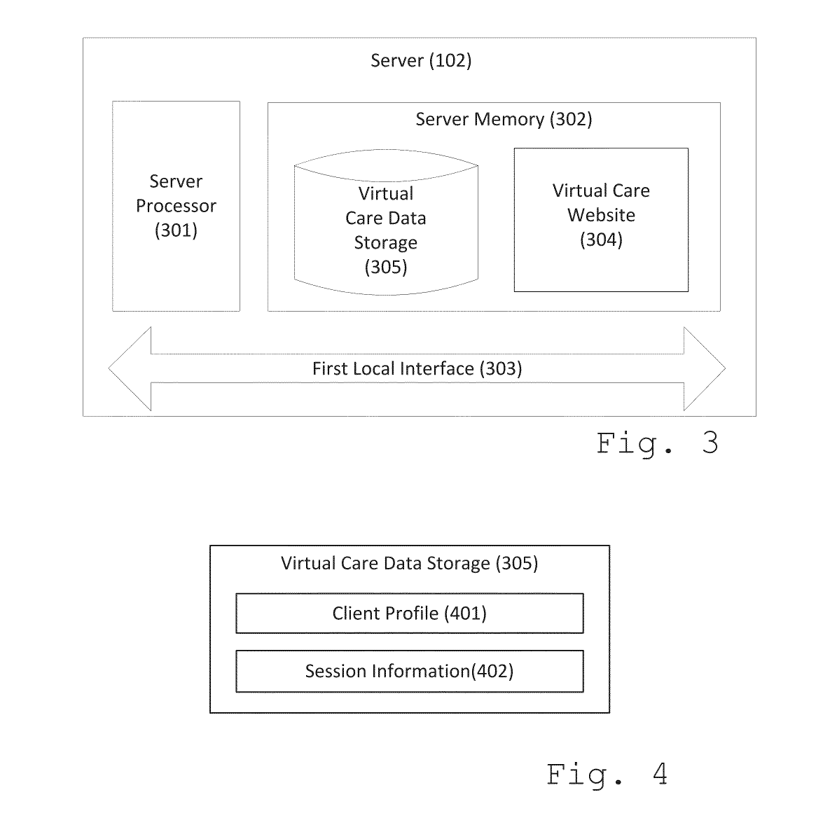

FIG. 3 illustrates a schematic diagram of server 102 according to an embodiment of the present disclosure. Server 102 can comprise a server processor 301, and a server memory 302 and a first local interface 303. First local interface 303 can be a program that controls a display for the user, which can allow user to view and/or interact with server 102. Server processor 301 can be a processing unit that performs set of instructions stored within server memory 302. Server memory 302 can comprises virtual care website 304, and a virtual care data storage 305. Virtual care website 304 can business logic for server 102. In this embodiment virtual care website 304 can contain HTML (Hyper Text Markup Language), scripts, and/or applications such as an embedded emergency care video chat application. Virtual care data storage 305 can be collections of data accessible through virtual care website 304. Further, virtual care website 304 can perform functions such as adding, transferring and retrieving information on virtual care data storage 305 using first local interface 303.

Server 102 includes at least one processor circuit, for example, having server processor 301 and server memory 302, both of which are coupled to first local interface 303. To this end, server 102 can comprise, for example, at least one server, computer or like device. First local interface 303 can comprise, for example, a data bus with an accompanying address/control bus or other bus structure as can be appreciated.

In particular, stored in the server memory 302 and executable by server processor 301 are virtual care website 304, and potentially other applications. Also stored in server memory 302 can be virtual care data storage 305 and other data. In addition, an operating system can be stored in server memory 302 and executable by server processor 301.

It is understood that there can be other applications that are stored in server memory 302 and are executable by server processor 301 as can be appreciated. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in server memory 302 and can be executable by server processor 301. In this respect, the term “executable” means a program file that is in a form that can ultimately be run by server processor 301. Examples of executable programs can be, for example, a compiled program that can be translated into machine code in a format that can be loaded into a random access portion of server memory 302 and run by server processor 301, source code that can be expressed in proper format such as object code that is capable of being loaded into a random access portion of server memory 302 and executed by server processor 301, or source code that can be interpreted by another executable program to generate instructions in a random access portion of provider memory 302 to be executed by server processor 301, etc. An executable program can be stored in any portion or component of server memory 302 including, for example, random access memory (RAM), read-only memory (ROM), hard drive, solid-state drive, USB flash drive, memory card, optical disc such as compact disc (CD) or digital versatile disc (DVD), floppy disk, magnetic tape, network attached/addressable storage or other memory components.

FIG. 4 illustrates virtual care data storage 305 comprising a client profile information 401 and a session information 402. Client profile 401 can comprise profiles of emergency care patients, which can include but is not limited to, a patient name, username, password, billing information, and/or primary care physician information. Session information 402 is related to provider sessions with patients and can comprise data transmissions such as chat logs, video logs, photo logs, and any other data exchanges between the physician and patient.

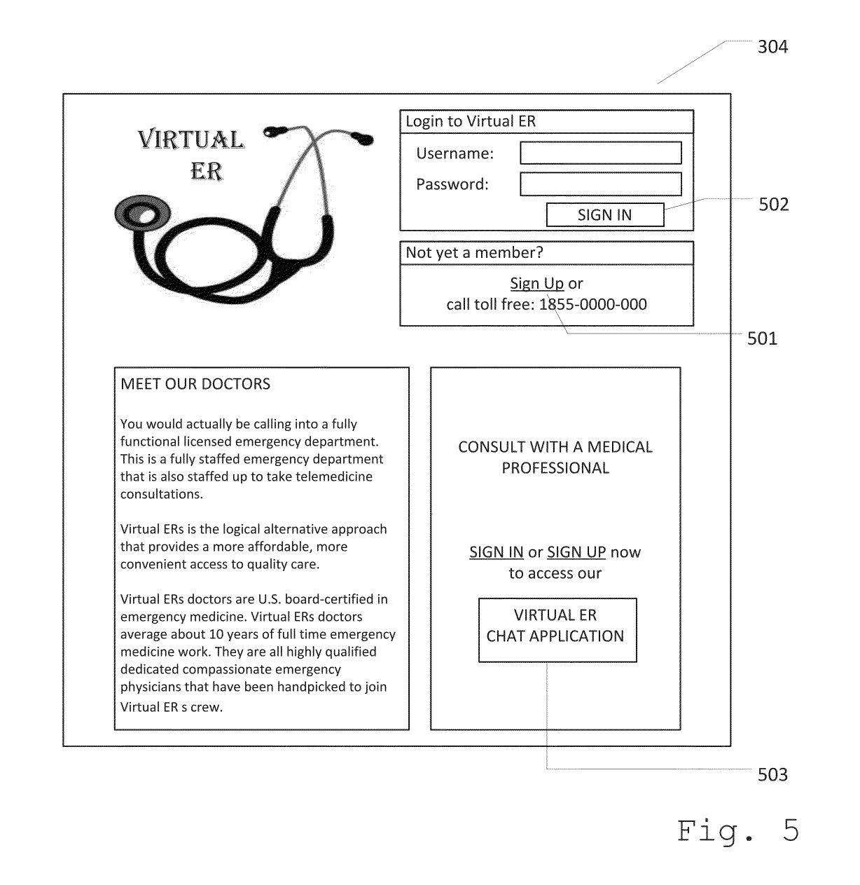

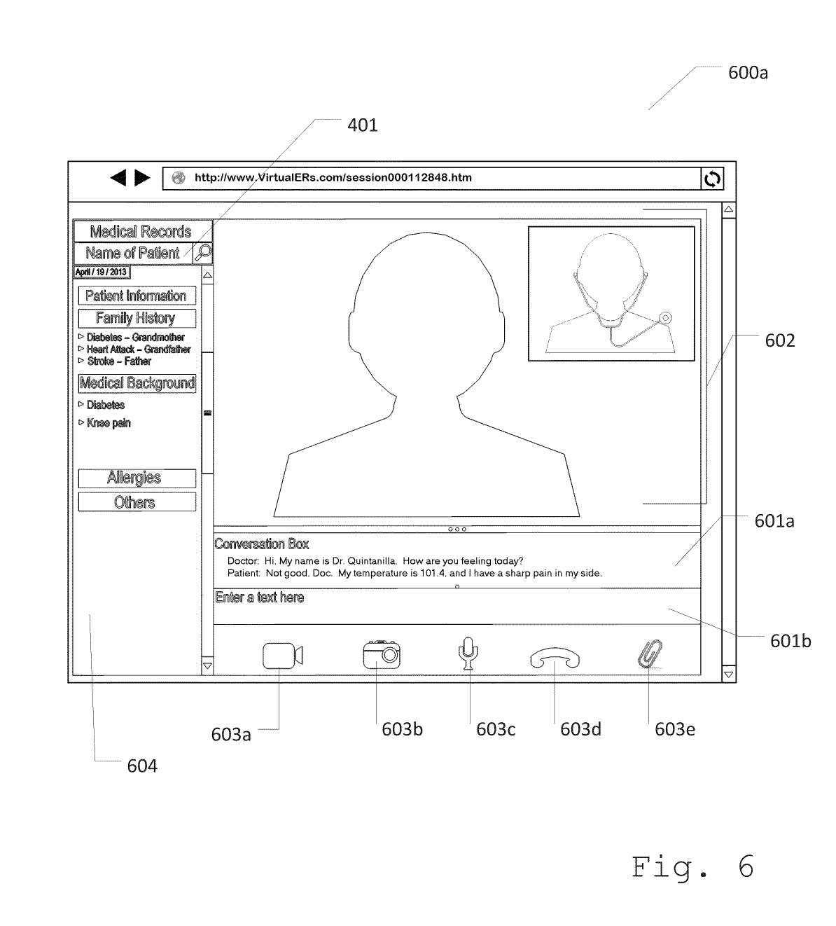

FIG. 5 illustrates an embodiment of virtual care website 304 comprising a user sign up link 501, and a user sign in link 502. User sign up link 501 can be an interactive tool, which can be displayed as a link or a button. User sign up link 501 can allow a user to be registered as a patient virtual care website 304. Moreover, registering on virtual care website 304 requires the user to supply unique credentials such as username, e-mail address, and password. As such, registering as patient on virtual care website 304 relates to creating a client profile 401 on virtual care data storage 305. User login link 502 can be an interactive tool, which can be displayed as a link or a button. User login link 502 can allow registered users to enter registered credentials to access virtual care website 304. Furthermore, once registered user is signed in on virtual care website 304, registered user can execute the embedded emergency care video chat application. In such scenario, a virtual chat application 503 in a form of interactive tool such as a link or button can be accessible to the registered user. As such, actuating virtual chat application 503 can launch the embedded emergency care video chat application within virtual care website 304.

FIG. 6 illustrates a physician chat window 600a during a web-based medical consultation session. In one embodiment, a physician can have virtual care website 304 running from his physician computer 101b. In this embodiment, the physician can be automatically signed in on virtual care website 304 or can have a direct access on virtual chat application 503. As such, virtual care website 304 can be a software application installed within a physical computer. In this embodiment, the software needs to be installed on physician's computer 101b to be able to communicate with server 102. In another embodiment, the physician can sign in on virtual care website 304 to launch virtual chat application 503 and to start providing medical care to patients. In such embodiment, the physician can use any computer 101 that is connected to network 103 to access virtual care website 304. Once signed in, the physician can click on virtual chat application 503 to display physician chat window 600a on physician computer 101b. Physician chat window 600a can comprise a chat box 601, a display pane 602, a plurality of chat tools 603, and a physician resource pane 604. Chat box 601 can comprise a conversation box 601a and a message field 601b. Conversation box 601a can display the exchange of messages between patient computer 101a and physician computer 101b. Message field 601b can be a text field that allows the user a place to key-in and compose their messages. Furthermore, text conversation exchanges between the physician and the patient can be stored as chat logs under session information 402. Display pane 602 can show an audio and video interaction between the patient and the physician. Chat tools 603 can be menus, links or buttons that allows user to perform desired action such as enable and disable video, capture image, mute audio, end session, or control volume of audio. Chat tools 603 on physician chat window 600a can comprise a video button 603a, a photo button 603b, an audio button 603c, an end session button 603d, and an attachment button 603e. Video button 603a can allow physician to disable or enable his webcam in displaying his video. Video button 603a and photo button 603b can be used by physician to still images and/or videos using camera 203 of patient computer 101a. As such, during an online medical consultation, images of a patient can be captured by the physician. Furthermore, captured video and images can be stored within session information 402 as video logs and photo logs. Audio button 603c can allow the physician to mute microphone on his computer 101b. End session button 603d allows the physician to terminate the session with the patient. In one embodiment, document files or image files such as laboratory results, x-ray results, and prescriptions can be attached and sent using attachment button 603e.

Physician resource pane 604 can be a portion on physician chat window 600a that displays information related to a consulting patient. In one embodiment, a portion on client profile 401 such as the patient's name, and primary care physician information, can be displayed on physician resource pane 604. Furthermore, previous session information 402 from the consulting patient can be displayed and/or accessible from physician resource pane 604. In one embodiment, important details from session information 402 can be displayed under physician resource pane 604 as medical records. In such embodiment, important details on session information 402 can be aggregated and displayed under physician resource pane 604 as medical records. In another embodiment, the physician can create, and update information displayed under physician resource pane 604.

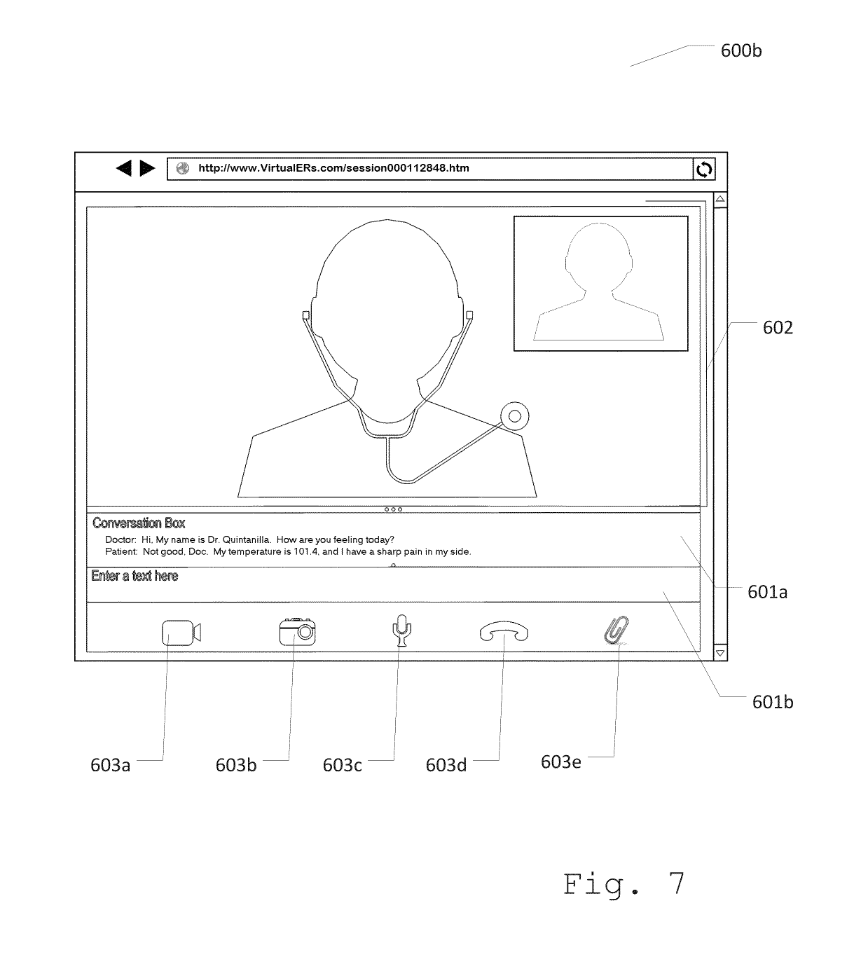

FIG. 7 illustrates a patient chat window 600b during a web-based medical consultation session. A click on virtual chat application 503 on patient computer 101a can execute embedded emergency care video chat application accessible to the patient through any web browser. Patient chat window 600b can also comprise chat box 601, display pane 602, and chat tools 603. Patient chat window 600b can allow the patient to consult the physician and get medical diagnosis, treatments, and/or advice. As such, the patient can consult with a physician in real-time and view the physician on display pane 602. Moreover, chat box 601 can be used by the patient to communicate with the physician. In one embodiment, chat tools 603 on patient computer 101a can be the same with chat tools 603 on provider computer 101b. In another embodiment, chat tools 603 on patient computer 101a can only comprise audio button 603c, end session button 603d, and attachment button 603e.

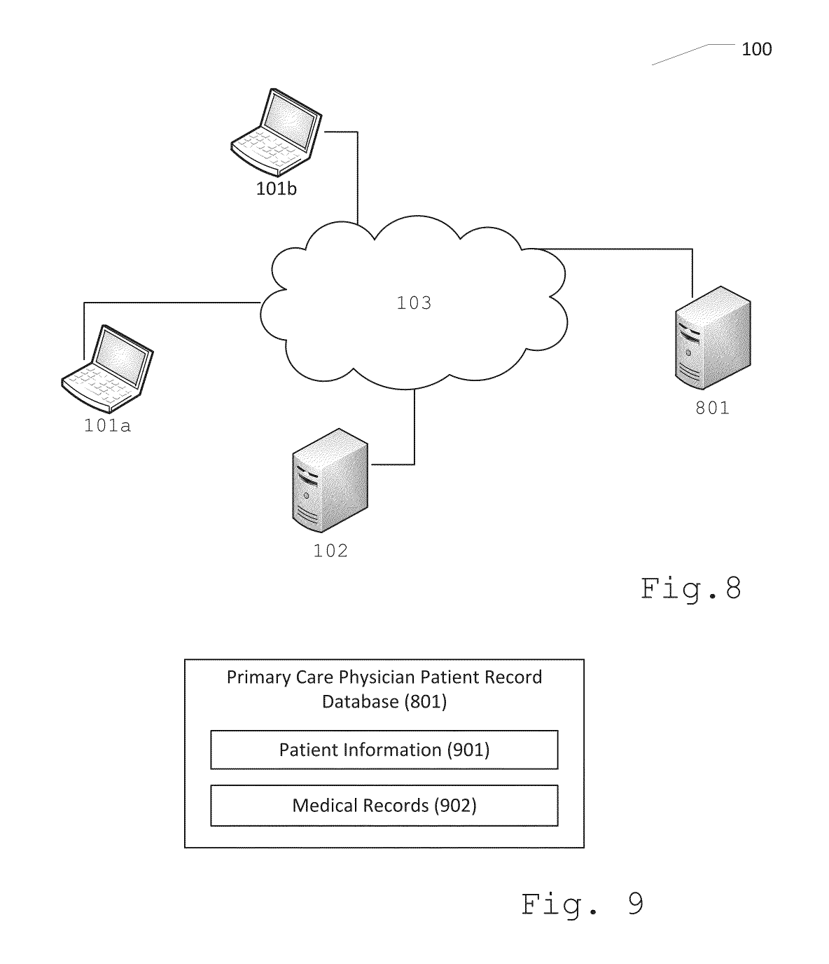

FIG. 8 illustrates a web-based emergency care system 100 further comprising a primary care physician (PCP) patient record database 801. PCP patient record database 801 represents at least one, but can be one or more devices used to store medical record information on individuals that is accessible through network 103. PCP patient record database 801 can be documentation containing medical information and medical histories of a patient. In this embodiment, server 102 can communicate with PCP patient record database 801 to gather and/or transfer stored information from PCP patient record database 801. Thus, data information such as client profile 401 and session information 402 from server 102 can be transferred and stored on PCP patient record database 801 through network 103. Similarly, data information stored within PCP patient record database 801 can also be accessible to server 102 through network 103. As such, medical record information stored within PCP patient record database 801 of an individual can be accessed by the physician through virtual care website 304.

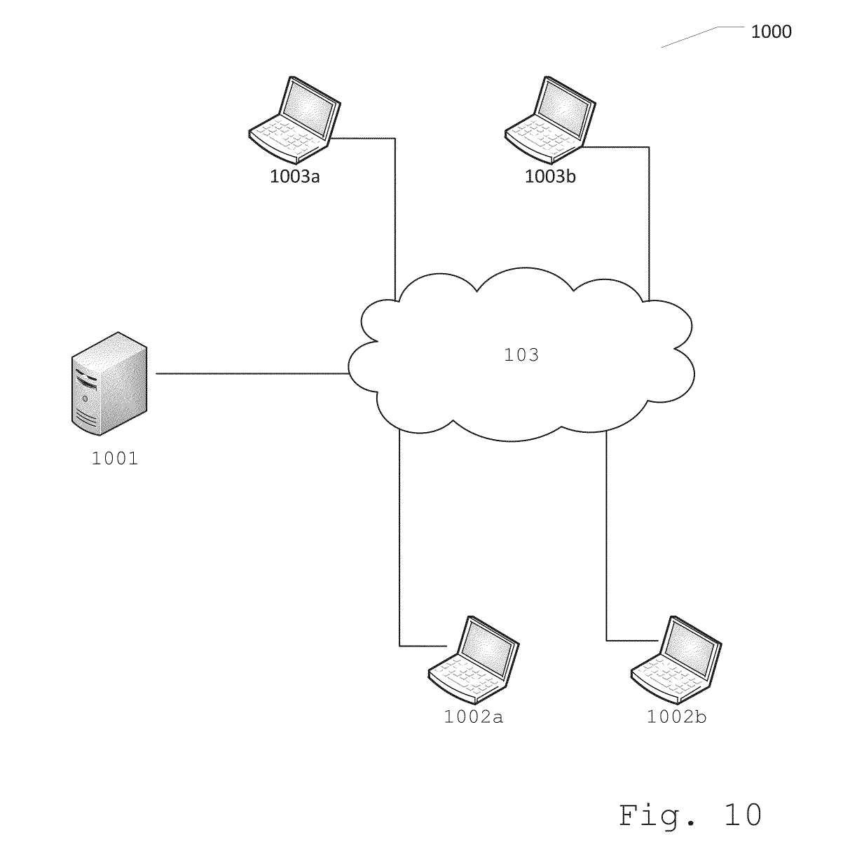

FIG. 9 illustrates primary care physician (PCP) patient record database 801 comprising a patient's information 901 and one or more medical records 902. Patient information 901 can comprise information related to a patient such as a patient name, a patient number, a patient contact information, insurance information, primary care physician (PCP) name, PCP contact information, and preferred pharmacy information. Medical records 902 can include, but are not limited to patient medical history, doctor visit records, current medications, and/or patient height and weight.

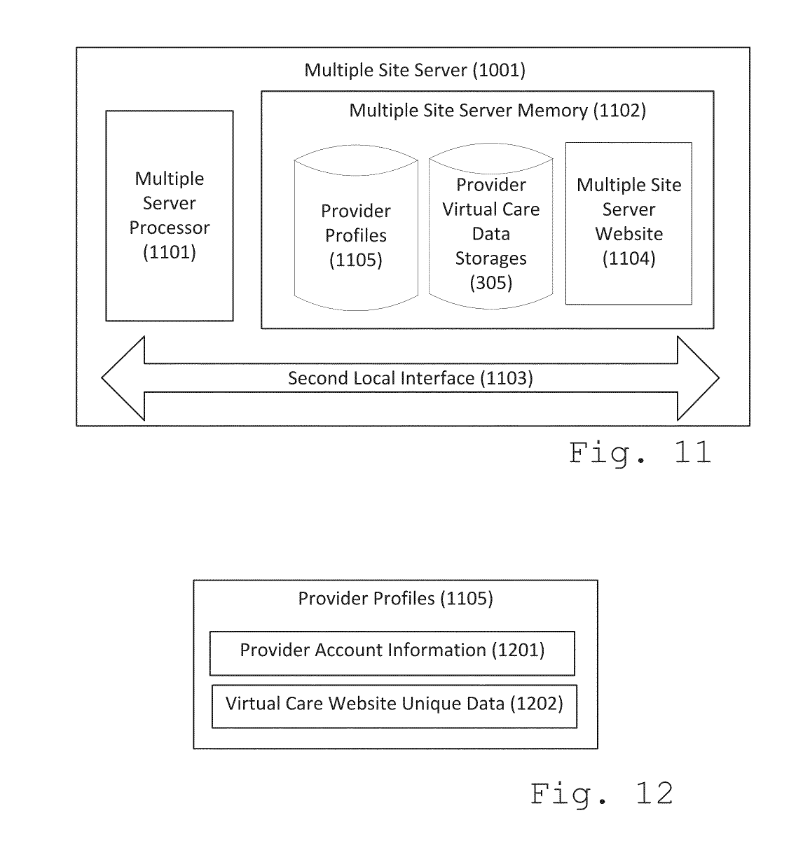

FIG. 10 illustrates a virtual care multiple site server system 1000. For purposes of this disclosure, virtual care multiple site server system 1000 can use any type of web hosting services such as dedicated hosting or cloud hosting. Furthermore, virtual care multiple site server system 1001 can be executed in any web platform which includes but are not limited to PHP, Java, or ASP.NET. Moreover, virtual care multiple site server system 1000 can use one or more web technologies. In one embodiment the web host can provide interface, modules, and other service application that can be used for managing virtual care multiple site server system 1000.

Virtual care multiple site server system 1000 can comprise a multiple site server 1001, a plurality of patients 1002, and a plurality of medical providers 1003. Multiple site server 1001 provides a centralized virtual platform accessible to patients 1002, and medical providers 1003. Multiple site server 1001 can represents at least one, but can be many servers, each connected to network 103 capable of performing computational task, and storing data information. Patients 1002 can be any individual that seeks medical care and treatments. Moreover, patients 1002 can be related to a user that has an access or owns patient computer 101a. Medical providers 1003 can be health care professionals, or health care institutions, which include but are not limited to doctors, physicians, medical practitioners, clinics, and hospitals. Furthermore, each medical provider 1003 can be related to physician computer 101b.

FIG. 11 illustrates a schematic diagram of a multiple site server 1001 according to an embodiment of the present disclosure. Multiple site server 1001 can comprise a multiple server processor 1101, and a multiple site server memory 1102 and a second local interface 1103. Second local interface 1103 can be a program that controls a display for the user, which can allow user to view and/or interact with multiple site server memory 1102. Multiple server processor 1101 can be a processing unit that performs set of instructions stored within multiple site server memory 1102. Multiple site server memory 102 comprises a multiple site server website 1104, a plurality of provider profiles 1105, and a plurality of provider virtual care data storages 305. Multiple site server website 1104 can be a program providing business logic for multiple site server 1001. In this embodiment multiple site server website 1104 can contain HTML (Hyper Text Markup Language), scripts, or applications such as an embedded emergency care video chat application. Each provider profiles 1105 can be collections of medical providers 1003 data accessible through multiple site server website 1104. Further, multiple site server website 1104 can perform functions such as adding, transferring and retrieving information on provider profiles 1105 and provider virtual care data storages 305 using second local interface 1103.

Multiple site server 1001 includes at least one processor circuit, for example, having multiple server processor 1101 and multiple site server memory 1102, both of which are coupled to second local interface 1103. To this end, multiple site server 1101 can comprise, for example, at least one server, computer or like device. Second local interface 1103 can comprise, for example, a data bus with an accompanying address/control bus or other bus structure as can be appreciated.

In particular, stored in the multiple site server memory 1102 and executable by multiple server processor 1101 are multiple site server website 1104, and potentially other applications. Also stored in multiple site server memory 1102 can be provider profiles 1105 and provider virtual care data storages 305 and other data. In addition, an operating system can be stored in multiple site server memory 1102 and executable by multiple server processor 1101.

FIG. 12 illustrates provider profiles 1105 comprising a provider's account information 1201, and a virtual care website unique data 1202. Provider profiles 1105 can comprise data information of each medical provider 1003 that are registered as health care providers on multiple site server website 1104. Provider account information 1201 can comprise account information of health care providers such as a health care professionals, or health care facilities such as, hospitals, clinics, and primary care centres. Provider account information 1201 can include medical provider 1003 information that include but are not limited to, health care provider's name, address, contact information, username, password, and billing information. Virtual care website unique data 1202 comprises data, which are related to logos, website contents, and or data files that are owned by or related to each medical provider 1003.

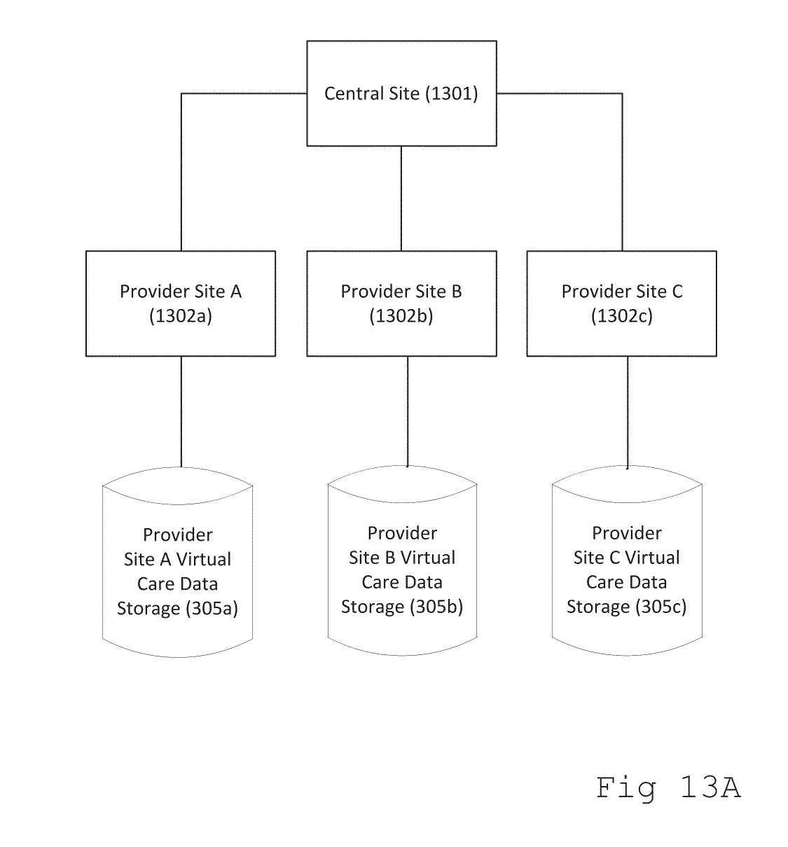

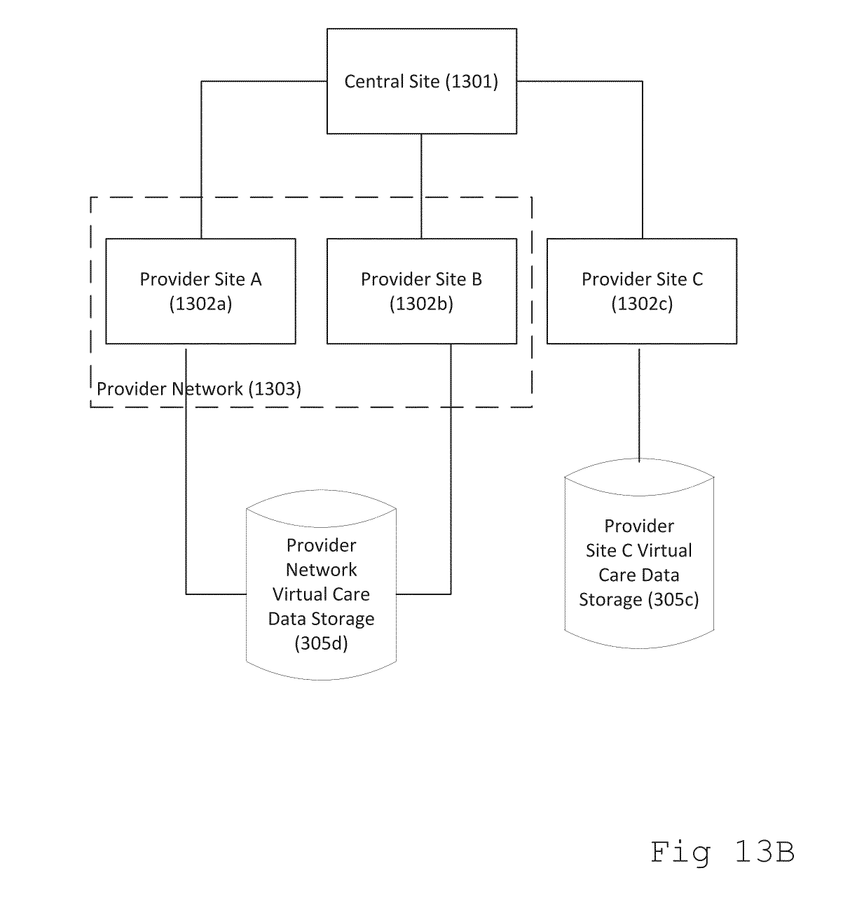

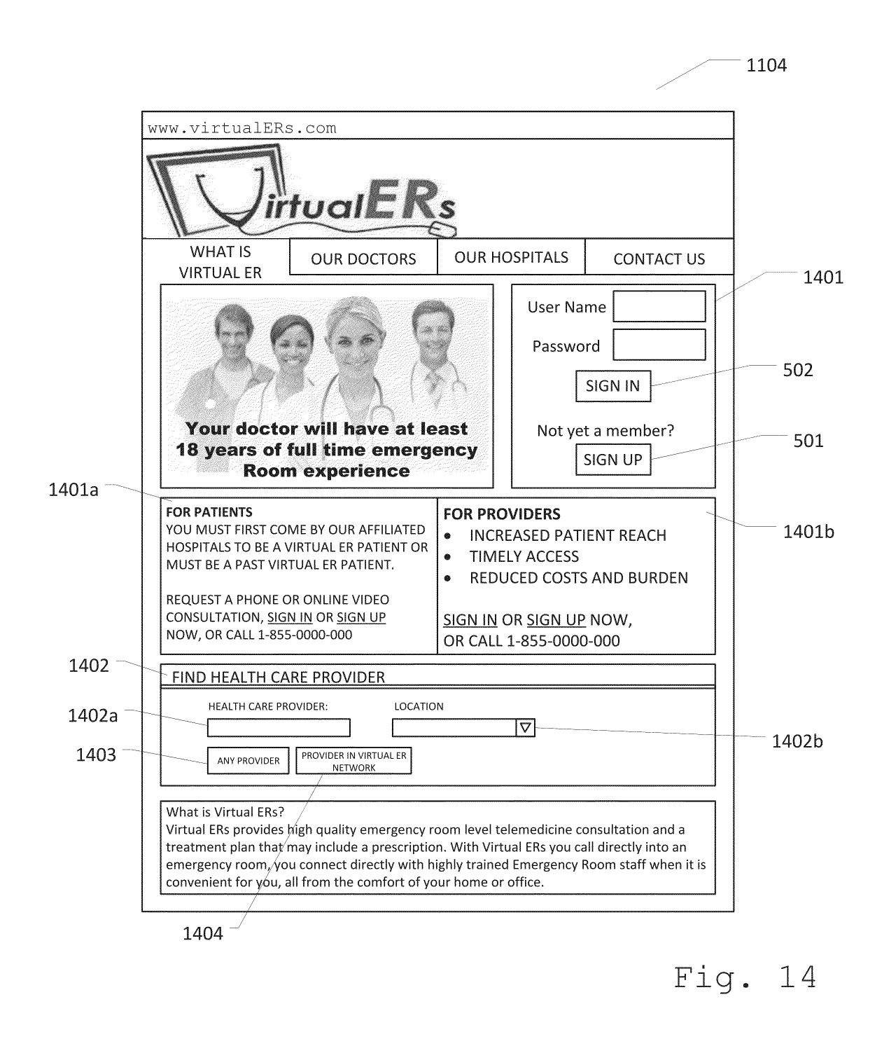

FIG. 13A illustrates a centralized hosting structure of multiple site server 1001 comprising a central site 1301, and a plurality of provider sites 1302. Central site 1301 can be the parent (main) website that provides a virtual platform for medical providers, physicians, and patients. Moreover in one embodiment, central site 1301 can refer to the entire installation of multiple site server 1001. Provider sites 1202 can be the children of central site 1201. Thus each provider site 1202 can be created according to one or more parameters provided by central site 1301. Parameters provided by central site can include but are not limited to page templates, background images, and page layout. Further, central site 1301 can be related to multiple site server website 1104 while provider sites 1302 can be related to providers virtual care websites 304. As such, central site 1301 manages and controls common application contents of each provider sites 1302. Further, each provider site 1302 can comprise provider virtual care data storage 305. Each provider virtual care data storage 305 can be associated to each of provider profiles 1105.

In this embodiment, each provider sites 1302 can be configured not to share any data with other provider sites. As an example, data information such as client profile 401a and session information 402a that is stored within provider site A virtual care data storage 305a can only be accessible to provider site A 1302a. Thus in such structure, data information stored within each of provider virtual care data storage 305 can be privately accessible to designated provider site.

FIG. 13B illustrates a centralized hosting structure for multiple site server 1001 further comprising a provider network 1303. In this embodiment, provider site A 1302a and provider site B 1302b can be a part of provider network 1303. As such, each of provider site 1302 that is part of a provider network 1303 can share data information stored within provider network virtual care data storage 305. In one embodiment, provider network 1303 can be a network of medical providers 1003 having standardized services. Furthermore, provider network 1303 can refer to independent health care operators that allow its members to employ services, use of brands or brand advertisements, and access to data records within said provider network 1303. Thus in such structure, provider site A 1302a and provider site B 1302b can be configured to share provider network virtual care data storage 305d. As such, provider site A 1302a and provider site B 1302b can each transfer, and/or gather data information such as client profile 401 and session information 402, which is stored within provider network virtual care data storage 305d. Therefore, data information stored within provider site data storage 305d can be configured viewable by the medical providers 1003 within provider network 1303. Further in this structure wherein provider site C 1302c is outside provider network 1303, data information that is shared within provider network 1303 can be inaccessible to provider site C 1302c. Similarly, data information of provider site C virtual care data storage 305c can be inaccessible to provider site A 1302a and provider site B 1302b.

Further, central site 1201 can be a domain name acquired from a web host while one or more provider sites 1202 can be a plurality of sub-domains under said domain name. As such, each provider sites 1202 can be tied to one subdomain. As URL addresses example, central site 1201 can use an address such as “www.virtualERs.com” while provider site A 1202a can use “www.franchise1.virtualERs.com”, provider site B 1202b can use “www.franchise2.virtualERs.com” and provider site C 1202c can acquire “www.drsmith.virtualERs.com”. In any of the three situations, a primary domain can be used, so that www.drsmith.virtualERs.com can be accessed by www.drsmith.com. Such information can be included in virtual care website unique data 1202.

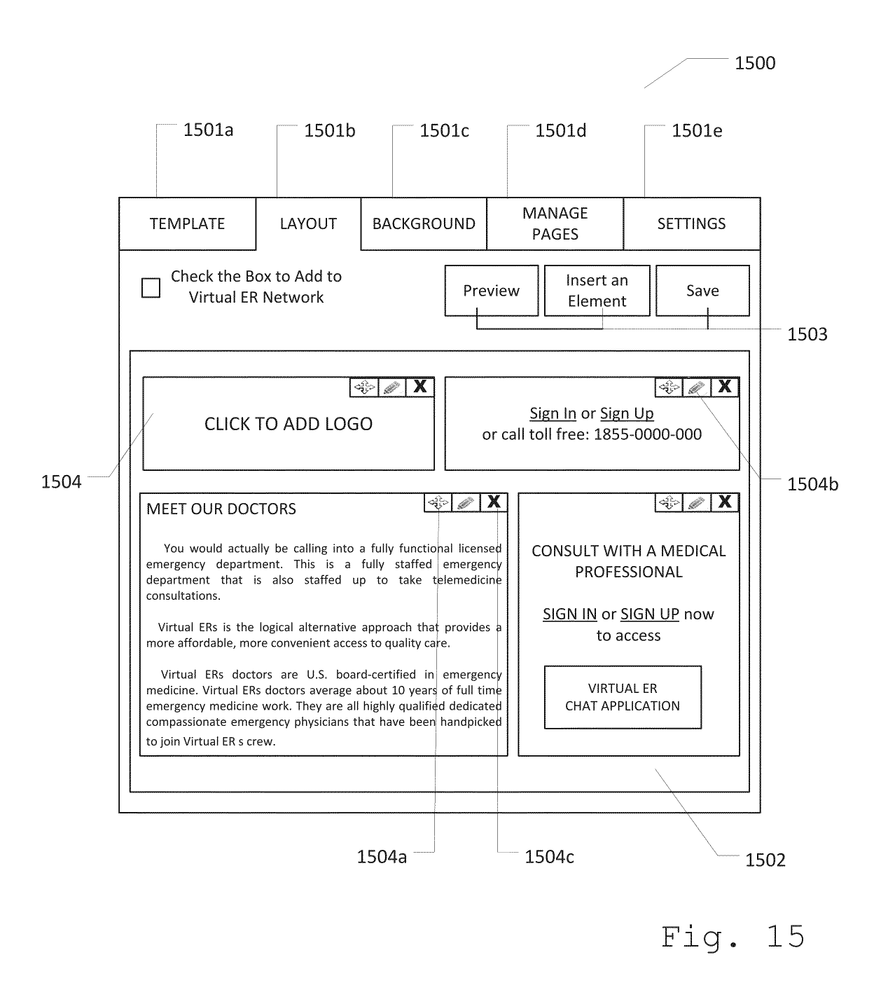

FIG. 14 illustrates an embodiment of multiple site server website 1104 comprising one or more authentication section 1401, and a medical provider section 1402. Authentication section 1401 can allow any individuals to sign up as a new user or sign in as a registered user on multiple site server website 1104. As such, authentication section 1401 can comprise sign up link 501, and sign in link 502. In one embodiment, a single authentication section 1401 can be displayed on multiple site server website 1104 that can allow any users such as patients, physicians, and/or health care institutions to sign in or sign up at the same place. In this embodiment, a user signing up on multiple site server website 1104 is directed at the registration website or web form wherein the user can enter unique credentials, such as username, e-mail address, and password. Furthermore, the user can also select his type of membership, which can be categorized into a patient, a medical professional, or a medical institution. Therefore, the fields on the registration page can change according to the selected type of membership of the user. Further, when a user tries to sign in under authentication section 1401, the credentials entered by the user can be used by multiple site server website 1104 to determine the user's type of membership. Thus, allowing multiple site server 1104 to identify and direct the user to his appropriate page or website.

In another embodiment, separate authentication sections 1401 can be provided to different type of users. As an example, a patient authentication section 1401a can be provided for patients 1002 while a provider authentication section 1401b can be provided for medical providers 1003. In an embodiment wherein a user is signing up as a patient, clicking sign up link 501 on patient authentication section 1401a can direct the user to a registration website or web form that comprises empty fields of client profile 401. Similarly, clicking on sign up link 501 under provider authentication section 1401b can take the user to the registration website or web form that comprises empty fields of provider account information 1201. In this embodiment, the user can have an option to sign up as a medical professional or a medical institution. Further, registering on multiple site server website 1104 relates to supplying unique credentials such as username, e-mail address, and password. Thus in this embodiment, a user signed up as a patient is not authorized to sign in under provider authentication section 1401b likewise a physician cannot use his registered physician's credential to sign in under provider authentication section 1401b. Moreover, signing in at the correct section and providing correct credentials can direct users to their appropriate page.

Medical provider section 1402 can be a portion on multiple site server website 1104 that lists, filters, or displays health care providers such as, health care professionals, or health care institutions that are registered as a medical provider 1003 on multiple site server website 1104. As such, every user that registers as medical provider 1003 on multiple site server website are added on the list of health care providers displayed under find medical provider section 1402. Medical provider section 1402 can comprise a health care provider name 1402a, a health care provider location 1402b, a first button 1403, and a second button 1404. Health care provider name 1402a can be a search box wherein name of medical provider 1003 can be entered. Health care provider name 1402a can aid user in limiting the search according to the name of health care provider. Health care provider location 1402b can be a dropdown list box that lists the location of each medical provider 1003. Thus, selecting from health care provider location 1402b limits the search result of medical provider 1003 according to location. First button 1403 and second button 1404 can be search buttons that when actuated returns search results according to a supplied search parameters. Clicking first button 1403 can return lists of any medical provider 1003 that matches the parameters entered on health care provider name 1402a, and health care provider location 1402b. While, clicking second button 1404 can return lists of medical provider 1003 that are part of provider network 1303, and which matches the parameters entered on health care provider name 1402a, and health care provider location 1402b.

In one embodiment, find medical provider section 1402 can be accessible to any unregistered users. In this embodiment, any individual can browse and search for medical providers 1003 that are signed up under multiple site server website 1104. In such embodiment, selecting at least one of medical provider 1003 from the search result can either direct the individual to provider's virtual care website 304.

Further, in another embodiment registered medical providers 1003 can also be listed and displayed on multiple site server website 1104 as an interactive list such as link, drop-down list, menu, or buttons, in one embodiment. In another embodiment, medical providers 1003 can be grouped as physicians or hospitals and be displayed on multiple site server website 1104 as tabs. This can simplify and aid any individuals and patient 1002 in searching for registered medical provider 1003. Moreover, having a list of medical provider 1003 can allow any user to browse through the list and know which health care provider offers a web-based or online emergency care. Furthermore, clicking on a desired medical provider 1003 from the lists of health care providers can direct the user to the selected provider virtual care website 304.

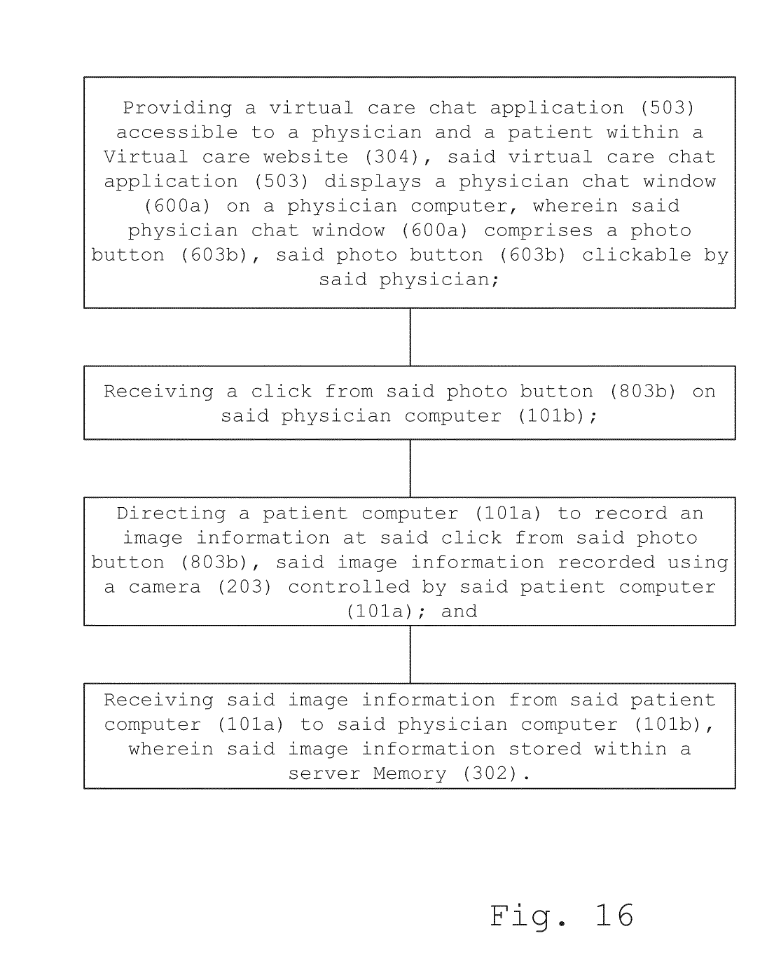

FIG. 15 illustrates a design page 1500 multiple site server website 1104. The graphical development environment for design page 1500 can be controlled by a script-based execution platform operating in multiple site server website 1104. As such, graphical user interface for each provider sites 1302 can be controlled and managed through central site 1301. Thus, generic or standard parameters such as templates, layouts, contents, and applications that can be used by each provider sites 1302 can be provided and available through central site 1301. Therefore, design page 1500 can be accessible to a registered medical provider 1003 after signing into multiple site server website 1104. Further design page 1500 can be related to a design mode wherein registered medical provider 1003 can customize a page according to the way they want their provider site 1302 to be seen by patients 1002. Design page 1500 can comprise a plurality of design tabs 1501, a workspace section 1502, and system buttons 1503.

Design tabs 1501 can comprise of interactive tools such as buttons or links that allow medical provider 1003 to customize the look of his own provider site 1302. Templates 1501a can be used as a guide or a pattern in creating a webpage. Moreover, webpage templates 1501a can allow provider to choose font, design, and format of provider site 1302. Furthermore, a plurality of elements 1504 can be added to the patient's webpage such as text, images, gifs, widgets, and applications. In one embodiment elements 1504 can be related to virtual care website unique data 1202. Furthermore, web contents, GIFs, and other data images selected from a provided template can be used by medical provider 1003 to customize his provider site 1302.

In another embodiment, medical provider 1003 can use HTML code or use CSS (Cascading Style Sheets) to create a more extensive layout and design for provider site 1302. Further each added elements can comprise a move button 1504a, an edit button 1504b, and a remove button 1504c. As such, each element 1504 that are added on workspace section 1502 can be re-arranged, edited, or removed. System buttons 1503 in this embodiment can allow user to enter a preview mode and a save mode. Preview mode can allow the provider designing the page to view or partially execute the patient's webpage. Moreover, preview mode can reflect any updates made on design mode. This can allow the provider to find out if there are problems such as broken links, size or formatting issues before saving design page 1500. Save mode can allow the provider to execute the changes made in design page 1500.

FIG. 16 illustrates an exemplary method for controlling a patient's camera 203 to capture an image information upon a physician's request. Any individual can access virtual care website 304 through any web browser but only registered patients can login on virtual care website 304 to start a web-based medical consultation session with a registered physician. Once registered users are signed in, virtual care website 304 provides a virtual chat application 503 accessible to registered physicians and patients. Physician chat window 600a can be displayed on physician computer 101b once virtual chat application 503 is clicked. Physician chat window 600a can comprise a chat box 601, a display pane 602, a plurality of chat tools 603, and a physician resource pane 604. Chat tools 603 can comprise a photo button 603b that can be clickable to the physician through physician chat window 600a. Photo button 603b can allow the physician to capture and record image information of a patient during the web-based medical consultation session. This can aid the physician in providing proper diagnosis and treatment to a consulting patient. Moreover, recorded image information can also be used to monitor the condition of the patient. Further, a click from photo button 603b can trigger server processor 301 to communicate with patient's computer 101a via network 103. In one embodiment, a permission request from provider's computer 101b can be sent to patient's chat window 600b to request an access on camera 203 of patient's computer 101a. Once the permission request is permitted by the patient, the physician can control camera 203 of patient's computer 101a. As such, at the click of photo button 603b, patient computer 101a can be directed to record image information of the patient. The image information captured from patient computer 101a can be stored within a server memory 302. As such, image information can be photo logs that can be stored in session information 402.

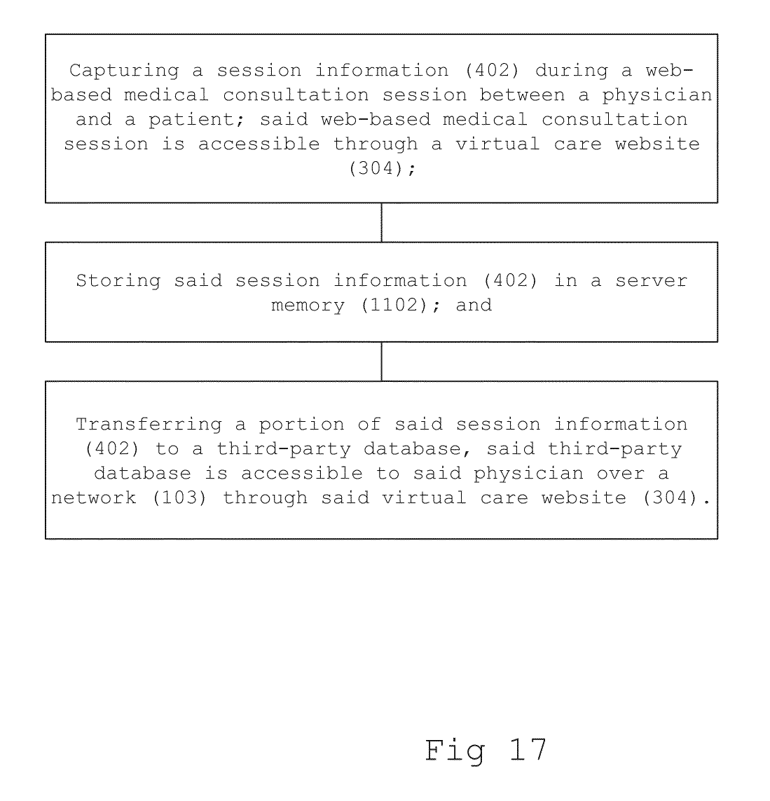

FIG. 17 illustrates an exemplary method for updating medical records of a third-party medical provider over a computer network. At the start of a web-based medical consultation session between a physician and a patient, session information 402 can be captured through a virtual chat application 503. The web-based medical consultation session is accessible from a virtual care website 304 by clicking virtual chat application 503. Once clicked, virtual chat application 503 opens a physician chat window 600a on a physician computer 101b. Further, session information 402 can include chat logs, video logs, photo logs, attachment files, and any other data transmission logs that are exchanged by the patient and the physician during the medical consultation. As such, each of said data transmission logs can be documented by the physician on a physician resource pane 604 of physician chat window 600a. Additionally, once physician chat window 600a opens the patient information, such as client profile 401 and session information 402 can be displayed under physician resource pane 604. Therefore in a scenario wherein, the patient has previous consultation session made through virtual care website 304, physician resource pane 604 can display the patient's client profile 401 and displays related data transmission logs or session information 402 that are made by the previous physician. Thus, data transmission logs made for each client profile 401 are aggregated, arranged, and displayed on physician resource pane 604 accordingly.

Further in another scenario wherein the patient needs an emergency medical service, virtual care website 304 can be accessed by the patient to consult any available physicians. In such scenario, the patient may have a third party primary care physician. As such, the attending physician on virtual care website 304 can still accommodate the patient and provide medical attention through virtual chat application 503. In this scenario, the patient can have medical records from his primary care physician wherein said medical records can be stored in a third-party primary care physician (PCP) patient record server or a PCP patient record database 801. As such, the attending physician can access the patient's medical record from PCP record database 801 through physician chat window 600a. In this scenario, server 102 can query PCP patient record database 801 to find patient information 901 that can match the emergency care patient. Thus, any session information 402 captured during the consultation can be stored under the medical records 902 of the consulting patient. In one embodiment, an authentication in a form of a password or a token can be required from the attending emergency physician before accessing medical records from PCP record database 801. In one embodiment, a medical record 902 on PCP patient record database 801 can be displayed under physician resource pane 604 once the physician pulls up client profile 401 of the patient. In another embodiment, a link to medical record 902 of the patient can be displayed on physician resource pane 604. In these embodiments, a reference such as a patient's name, or a patient's reference number, can be used to relate client profile 401 on server memory 302 with patient information 901 on PCP patient record database 801. In such scenario, the attending physician can review medical records 902 of the patient's primary care physician. Therefore, the physician can provide proper and timely diagnosis and treatment to the patient. Once, consultation session is finished the physician or the patient can choose to end the session and log out. As such, data transmission logs that are made during medical consultation session can be stored within session information 402. Furthermore, a portion of session information 402 can be transferred over network 103 and be added as medical records 902 on a third party database such as PCP patient record database 801. As such, medical records of a patient can always be accessible to the physician over network 103 through virtual care website 304. Additionally, the patients on virtual care website 304 can be assured that their medical records are kept updated and accessible anytime and anywhere over a computer network.

Server memory 302 and multiple site server memory 1102 can include both volatile and non-volatile memory and data storage components. Volatile components do not retain data values upon loss of power. Non-volatile components, on the other hand, retain data upon a loss of power. Thus, server memory 302 and multiple site server memory 1102 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, server processor 301 and multiple server processor 1101 can represent multiple processors. Likewise, server memory 302 and multiple site server memory 1102 can represent multiple memories that operate in parallel processing circuits, respectively. In such a case, first local interface 303 and second local interface 1103 can be an appropriate network, including network 103 that facilitates communication between any two of the multiple server processors 301 and multiple server processor 1101, between any server processor 301 and multiple server processor 1101 and any of the server memory 302 and multiple site server memory 1102, or between any two of the server memory 302 and multiple site server memory 1102, etc. First local interface 303 and second interface 1103 can comprise additional systems designed to coordinate this communication, including, but not limited to, performing load balancing. Server processor 301 and multiple server processor 1101 can be of electrical or of some other available construction.

Although virtual care website 304 and multiple site server website 1104, and other various systems described herein can be embodied in software or code executed by general purpose hardware discussed above, virtual care website 304 and multiple site server website 1104 can also be embodied in dedicated hardware or a combination of software/general purpose hardware and dedicated hardware. If embodied in dedicated hardware, each virtual care website 304 and multiple site server website 1104 can be implemented as a circuit or state machine that employs a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIG. 16 and FIG. 17 shows the functionality and operation of an implementation of portions of virtual care website 304 and multiple site server website 1104. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as server processor 301 and multiple server processor 1101 in a computer system or other system. The machine code can be converted from the source code, etc. If embodied in hardware, each block can represent a circuit or a number of interconnected circuits to implement the specified logical function(s).

Although the flowcharts of FIG. 16 and FIG. 17 show a specific order of execution, the order of execution can differ from what is depicted. For example, the order of execution of two or more blocks can be rearranged relative to the order shown. Also, two or more blocks shown in succession in flowcharts of FIG. 16 and FIG. 17 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. All such variations are within the scope of the present disclosure.

Also, any logic or application described herein that comprises software or code, including virtual care website 304 and multiple site server website 1104, can be embodied in any computer-readable storage medium for use by or in connection with an instruction execution system such as, server processor 301 and multiple server processor 1101 in a computer system or other system. The logic can comprise statements including instructions and declarations that can be fetched from the computer-readable storage medium and executed by the instruction execution system.

In the context of the present disclosure, a “computer-readable storage medium” can be any medium that can contain, store, or maintain the logic or application described herein for use by or in connection with the instruction execution system. The computer-readable storage medium can comprise any one of many physical media, such as electronic, magnetic, optical, electromagnetic, infrared, or semiconductor media. More specific examples of a suitable computer-readable storage medium can include, but are not limited to, magnetic tapes, magnetic floppy diskettes, magnetic hard drives, memory cards, solid-state drives, USB flash drives, or optical discs. Also, the computer-readable storage medium can be a random access memory (RAM), including static random access memory (SRAM), dynamic random access memory (DRAM) or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for updating medical records of a third-party medical provider over a computer network comprising
a server memory that stores
a client profile;
a session information related to each of said client profile; and
a virtual care website; and
a server processor that according to instructions from said virtual care website
captures said session information between a physician and a patient through a virtual chat application, further wherein said patient related with said client profile;
queries a third-party medical provider to match patient information with said patient, wherein said patient information is associated with one or more medical records; and
stores said session information under said medical records of said patient that matches said client profile.

2. The system of claim 1 wherein said emergency care patient is a patient of said third-party medical provider.

3. The system of claim 1 wherein said medical records are stored within said server memory.

4. The system of claim 1 wherein said medical record is stored within said third-party medical provider.

5. The system of claim 4 wherein said third-party medical provider comprises a primary care physician patient (PCP) server.

6. The system of claim 1 wherein said client profile relates to unique credentials of said patient supplied during registering on a virtual care website.

7. The system of claim 6 wherein said patient signs in on said virtual care website using said unique credentials to access a virtual care chat application, said virtual care chat application provides said web based medical consultation.

8. The system of claim 1 wherein said session information are data transmission logs exchanged by said patient and said physician during said web-based medical consultation.

9. A method for updating medical records of a third-party medical provider over a computer network comprising
capturing a session information between a physician and a patient through a virtual chat application, further wherein said patient related with a client profile;
querying a third-party medical provider to match a patient information with said patient, wherein said patient information associated to one or more medical records; and
storing said session information under said medical records of said patient that matches said client profile.

10. The method of claim 9, prior to capturing said session information comprising the steps of signing into said virtual care website, further wherein said web-based medical consultation accessible through a virtual care chat application.

11. The method of claim 9 comprising the step of displaying said medical records of said patient on a physician chat window.

12. The method of claim 9, prior to capturing said session information, comprising the step of requesting permission from said patient to capture said session information.

13. The method of claim 9, prior to querying a third-party medical provider, comprising the step of authenticating said physician.

14. The method of claim 9, further comprising the step of clicking a chat tool to start capturing a portion of said session information.

15. A non-transitory computer readable storage medium having a computer readable program code embodied therein, wherein the computer readable program code is adapted to be executed to implement the method of claim 1.
